(19) United States
(12) Patent Application Publication
(10) Pub. No.: US 2020/0066032 A1
(43) Pub. Date: Feb. 27, 2020

(54) Automated Luminaire Commissioning Using Computer Vision and Light-Based Communication

(71) Applicants: Yang Li, Georgetown, MA (US); Khadige Abboud, Somerville, MA (US); Sergio Bermudez, Boston, MA (US); Helmar Adler, Danvers, MA (US)

(72) Inventors: Yang Li, Georgetown, MA (US); Khadige Abboud, Somerville, MA (US); Sergio Bermudez, Boston, MA (US); Helmar Adler, Danvers, MA (US)

(73) Assignee: OSRAM SYLVANIA Inc., Wilmington, MA (US)

(21) Appl. No.: 16/108,749

(22) Filed: Aug. 22, 2018

(51) Int. Cl. G06T 17/05; G06T 15/20; H04B 10/116; H04W 4/44; H04W 64/00; H04W 8/00

(52) U.S. Cl. CPC G06T 17/05; G06T 15/205; H04W 8/005; H04W 4/44; H04W 64/003; H04B 10/116

(57) ABSTRACT

Aspects of the present disclosure include systems and methods for automated luminaire commissioning using computer vision and light-based communications (“LCom”). In some examples, locations of an installation of luminaires can be measured and recorded with a mobile commissioning device equipped with an image capture device and image processing and simultaneous localization and mapping software.

### FIELD OF THE DISCLOSURE

The present disclosure generally relates to the field of luminaire commissioning. In particular, the present disclosure is directed to automated luminaire commissioning using computer vision and light communications.

### BACKGROUND

Knowing the location of luminaires within a building can be useful for a variety of reasons. In applications of indoor positioning, tool positioning, dimensional metrology, 3D reconstruction, and augmented/virtual reality, luminaires equipped with light-based communication (LCom) and computer vision based techniques have been proposed to achieve the positioning of a camera-equipped computing device. In such cases, the camera position greatly relies on knowing the positions and identifications (IDs) of the luminaires.

In some other cases, such as wireless network commissioning, knowing the positioning of luminaires equipped with radio devices can facilitate commissioning procedures (e.g., assigning groups, associate functionalities) and/or supporting security features of a wireless network including such radio devices. The IDs of wireless-enabled luminaires may be of interest for setting up a network by obtaining the ID, e.g., MAC addresses, of the luminaires and for maintaining a secure luminaire network by mapping the IDs to their positions.

Traditional methods used to determine the position of luminaires within a space typically include a commissioning process after the luminaires are installed, in which the location of each luminaire within a space is measured and recorded. Existing techniques for measuring the position of a luminaire during a commissioning process typically rely on manual methods including the use of hand tools such as measuring tapes, rulers, compasses, laser levels, and so on. A commissioning process using such manual methods can be tedious and time-consuming and the accuracy of the measurement results are prone to human errors.

### SUMMARY OF THE DISCLOSURE

In one implementation, the present disclosure is directed to a method for determining a location of a plurality of luminaires installed in a space, the plurality of luminaires including an anchor group of luminaires and a second group of luminaires. The method includes receiving, from an image capture device, a first image containing one or more of the luminaries in the anchor group, determining, by a mobile commissioning device, a unique ID for at least one of the one or more luminaires in the anchor group from the first image, obtaining, by the mobile commissioning device, location information of the at least one of the one or more luminaires in the anchor group based on the unique IDs, determining, by the mobile commissioning device, a location of the mobile commissioning device based on the first image and the location information, updating, by the mobile commissioning device, a virtual map of the space based on the first image, receiving, from the image capture device, a second image containing a first luminaire in the second group of luminaires, and calculating, by the mobile commissioning device, a location of the first luminaire from the second image and the virtual map.

In some embodiments, the unique ID for the at least one of the one or more luminaires in the anchor group is encoded in light signals emitted by the at least one of the one or more luminaires in the anchor group. In some embodiments, obtaining location information of the at least one of the one or more luminaires in the anchor group includes at least one of matching, by the mobile commissioning device, each unique ID with corresponding location information in a luminaire location database that associates unique IDs with luminaire locations, and decoding, by the mobile commissioning device, the location information from light emitted by one or more of the luminaires in the anchor group that encode the location information. In some embodiments, calculating the location of the first luminaire includes determining, by the mobile commissioning device, a virtual location of the mobile commissioning device in the virtual map, determining, by the mobile commissioning device, a virtual location of the first luminaire in the virtual map, and converting, by the mobile commissioning device, the virtual location of the first luminaire to the location of the first luminaire in the space. In some embodiments, the method further includes calculating, by the mobile commissioning device, a transformation between the virtual map and global coordinates in the space, in which converting the virtual location of the first luminaire includes converting the virtual location to a global coordinate location in the space using the transformation. In some embodiments, the mobile commissioning device executes a simultaneous localization and mapping application to update the virtual map of the space and calculate the location of the first luminaire simultaneously. In some embodiments, the method further includes determining, by the mobile commissioning device, a unique ID of the first luminaire from the second image, in which the first luminaire encodes its unique ID in a light signal emitted by the first luminaire. In some embodiments, the mobile commissioning device is an autonomous vehicle.

In another implementation, the present disclosure is directed towards a computing device configured to determine a location of a plurality of luminaires installed in a space, the plurality of luminaires including an anchor group of luminaires and a second group of luminaires. The computing device includes an image capture device configured to obtain a first image containing one or more of the luminaries in the anchor group, and obtain a second image containing a first luminaire in the second group of luminaires. The computing device also includes a processor configured to determine a unique ID for at least one of the one or more luminaires in the anchor group from the first image, obtain location information of the at least one of the one or more luminaires in the anchor group based on the unique IDs, determine a location of the computing device based on the first image and the location information, update a virtual map of the space based on the first image, receive the second image from the image capture device, and calculate a location of the first luminaire from the second image and the virtual map.

In some embodiments, the unique ID for the at least one of the one or more luminaires in the anchor group is encoded in light signals emitted by the at least one of the one or more luminaires in the anchor group. In some embodiments, the processor is configured to obtain location information of the at least one of the one or more luminaires in the anchor group by at least one of matching each unique ID with corresponding location information in a luminaire location database that associates unique IDs with luminaire locations, and decoding the location information from light emitted by one or more of the luminaires in the anchor group that encode the location information. In some embodiments, the processor is configured to calculate the location of the first luminaire by determining a virtual location of the mobile commissioning device in the virtual map, determining a virtual location of the first luminaire in the virtual map, and converting the virtual location of the first luminaire to the location of the first luminaire in the space. In some embodiments, the processor is further configured to calculate a transformation between the virtual map and global coordinates in the space, in which converting the virtual location of the first luminaire includes converting the virtual location to a global coordinate location in the space using the transformation. In some embodiments, the processor is configured to execute a simultaneous localization and mapping application to update the virtual map of the space and calculate the location of the first luminaire simultaneously. In some embodiments, the processor is further configured to determine a unique ID of the first luminaire from the second image, in which the first luminaire encodes its unique ID in a light signal emitted by the first luminaire. In some embodiments, the computing device is an autonomous vehicle.

In another implementation, the present disclosure is directed towards a non-transitory processor-readable storage medium having stored thereon processor executable instructions configured to cause a processor of a controller to perform operations including receiving, from an image capture device, a first image containing one or more luminaries in an anchor group of luminaires in a space, determining a unique ID for at least one of the one or more luminaires in the anchor group from the first image, obtaining location information of the at least one of the one or more luminaires in the anchor group based on the unique IDs, determining a location of the mobile commissioning device based on the first image and the location information, updating a virtual map of the space based on the first image, receiving, from the image capture device, a second image containing a first luminaire in a second group of luminaires in the space, and calculating a location of the first luminaire from the second image and the virtual map.

In some embodiments, obtaining location information of the at least one of the one or more luminaires in the anchor group includes at least one of matching each unique ID with corresponding location information in a luminaire location database that associates unique IDs with luminaire locations, and decoding the location information from light emitted by one or more of the luminaires in the anchor group that encode the location information. In some embodiments, calculating the location of the first luminaire includes determining a virtual location of the mobile commissioning device in the virtual map, determining a virtual location of the first luminaire in the virtual map, and converting the virtual location of the first luminaire to the location of the first luminaire in the space. In some embodiments, the process further including calculating a transformation between the virtual map and global coordinates in the space, in which converting the virtual location of the first luminaire includes converting the virtual location to a global coordinate location in the space using the transformation.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, in which:

FIG. 1 is a block diagram illustrating an example system for luminaire commissioning;

FIG. 2 is a side view of a MCD located below an installation of luminaires to be commissioned;

FIG. 3 is a top view of the MCD and installation of luminaires; and

FIG. 4 illustrates a method of luminaire commissioning using computer vision and light communications.

### DETAILED DESCRIPTION

Aspects of the present disclosure include systems and methods for automated luminaire commissioning using computer vision and light-based communications (“LCom”). In some examples, locations of an installation of luminaires can be measured and recorded using a mobile commissioning device (MCD) equipped with an image capture device (ICD) and image processing and simultaneous localization and mapping (SLAM) algorithms. In one example, an MCD may determine its initial position by capturing an image of a first set of anchor luminaires, in which the location of each of the anchor luminaires is known. After determining the initial position of the MCD, the MCD can move around the space(s) where the installation of luminaires are located, and determine the location of the remaining luminaires using SLAM algorithms and techniques. Such systems and methods for automated luminaire commissioning can provide a variety of advantages, including reduced manpower needed to commission an installation of luminaires, the ability to implement an automated commissioning process through the use of MCDs in the form of robots and/or autonomous vehicles and/or drones and the ability to achieve highly accurate location information for an installation of luminaires, for example, millimeter to centimeter level of accuracy.

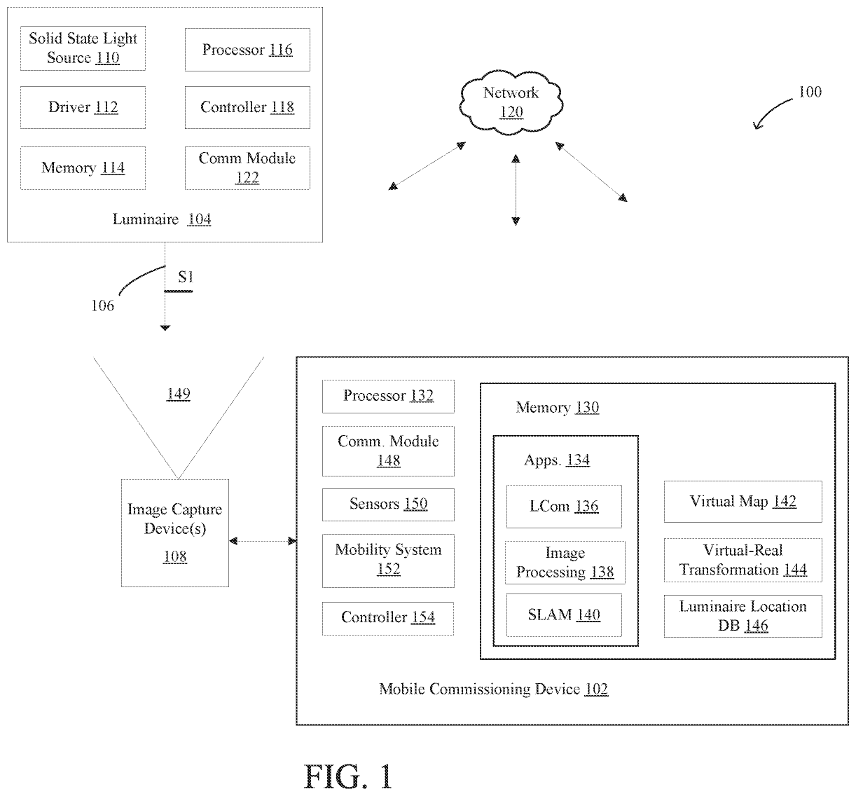

FIG. 1 illustrates an example system 100 for luminaire commissioning that includes a mobile commissioning device (MCD) 102 that is configured to determine a location of each of a plurality of luminaires 104 (only one illustrated) during a luminaire commissioning process. Luminaire 104 is equipped with LCom for encoding a signal S in light output 106 from the luminaire. The light output 106 utilized by luminaire 104 to emit signal S may be of any spectral band, visible or otherwise, and may be of any intensity, as desired for a given target application or end-use. In accordance with some embodiments, luminaire 104 may be configured to transmit a pulsing light signal encoded with data (signal S1), and a given receiving device, such as MCD 102, may be configured to detect signal S1 encoded with data via one or more ICDs 108, which may be a still-image camera, video camera, and/or ambient light sensor. As described more below, MCD 102 may be configured to image a first set of luminaires 104 each having a known location to localize and orient MCD 102 within a space, and then MCD 102 may be configured to move around the space, imaging additional luminaires 104 whose positions are unknown and calculating the positions of the additional luminaires.

Components of Luminaire 104

In the illustrated example, luminaire 104 includes one or more solid-state light sources 110. The quantity, density, and arrangement of solid-state light sources 110 utilized in a given luminaire 104 may be customized as desired for a given target application or end-use. A given solid-state light source 110 may include one or more solid-state emitters, which may be any of a wide range of semiconductor light source devices, such as, for example, a light-emitting diode (LED), an organic light-emitting diode (OLED), a polymer light-emitting diode (PLED), and/or a combination of any one or more thereof. A given solid-state emitter may be configured to emit electromagnetic radiation (e.g., light), for example, from the visible spectral band and/or other portions of the electromagnetic spectrum not limited to the infrared (IR) spectral band and/or the ultraviolet (UV) spectral band, as desired for a given target application or end-use. In some embodiments, a given solid-state emitter may be configured for emissions of a single correlated color temperature (CCT) (e.g., a white light-emitting semiconductor light source). In some other embodiments, however, a given solid-state emitter may be configured for color-tunable emissions. For instance, in some cases, a given solid-state emitter may be a multi-color (e.g., bi-color, tri-color, etc.) semiconductor light source configured for a combination of emissions, such as red-green-blue (RGB), red-green-blue-yellow (RGBY), red-green-blue-white (RGBW), dual-white; and/or a combination of any one or more thereof. A given solid-state emitter can be packaged or non-packaged, as desired, and in some cases may be populated on a printed circuit board (PCB) or other suitable intermediate/substrate. In some cases, power and/or control connections for a given solid-state emitter may be routed from a given PCB to a driver and/or other devices/componentry, as desired. Other suitable configurations for the one or more solid-state emitters of a given solid-state light source 110 will depend on a given application and will be apparent in light of this disclosure.

A given solid-state light source 110 also may include one or more optics optically coupled with its one or more solid-state emitters. In accordance with some embodiments, the optic(s) of a given solid-state light source 110 may be configured to transmit the one or more wavelengths (e.g., visible, UV, IR, etc.) emitted by solid-state emitter(s) optically coupled therewith. The optic(s) may include an optical structure (e.g., a window, lens, dome, etc.) formed from any of a wide range of optical materials known in the art. In some cases, the optic(s) of a given solid-state light source 110 may be formed from a single (e.g., monolithic) piece of optical material to provide a single, continuous optical structure. In some other cases, the optic(s) of a given solid-state light source 110 may be formed from multiple pieces of optical material to provide a multi-piece optical structure. In some cases, the optic(s) of a given solid-state light source 110 may include one or more optical features, such as, for example an anti-reflective (AR) coating, a reflector, a diffuser, a polarizer, a brightness enhancer, a phosphor material, e.g., which converts light received thereby to light of a different wavelength, and/or a combination of any one or more thereof. In some embodiments, the optic(s) of a given solid-state light source 110 may be configured, for example, to focus and/or collimate light transmitted therethrough. Other suitable types, optical transmission characteristics, and configurations for the optic(s) of a given solid-state light source 110 will depend on a given application and will be apparent in light of this disclosure.

In accordance with some embodiments, the one or more solid-state light sources 110 of luminaire 104 may be electronically coupled with a driver 112. In some cases, driver 112 may be an electronic driver (e.g., single-channel; multi-channel) configured, for example, for use in controlling the one or more solid-state emitters of a given solid-state light source 110. For instance, in some embodiments, driver 112 may be configured to control the on/off state, dimming level, color of emissions, correlated color temperature (CCT), and/or color saturation of a given solid-state emitter (or grouping of emitters). Driver 112 may utilize any of a wide range of driving techniques known in the art, including, for example, a pulse-width modulation (PWM) dimming protocol, a current dimming protocol, a triode for alternating current (TRIAC) dimming protocol, a constant current reduction (CCR) dimming protocol, a pulse-frequency modulation (PFM) dimming protocol, a pulse-code modulation (PCM) dimming protocol, a line voltage (mains) dimming protocol (e.g., dimmer is connected before input of driver 112 to adjust AC voltage to driver 112), and/or a combination of any one or more thereof. Other suitable configurations for driver 112 and lighting control/driving techniques will depend on a given application and will be apparent in light of this disclosure.

A given solid-state light source 110 also may include or otherwise be operatively coupled with other circuitry/componentry, for example, which may be used in solid-state lighting. For instance, a given solid-state light source 110 (and/or luminaire 104) may be configured to host or otherwise be operatively coupled with any of a wide range of electronic components, such as power conversion circuitry (e.g., electrical ballast circuitry to convert an AC signal into a DC signal at a desired current and voltage to power a given solid-state light source 110), constant current/voltage driver componentry, transmitter and/or receiver (e.g., transceiver) componentry, and/or local processing componentry. When included, such componentry may be mounted, for example, on one or more driver 112 boards, in accordance with some embodiments.

Example luminaire 104 may include memory 114 and one or more processors 116. Memory 114 can be of any suitable type (e.g., RAM and/or ROM, or other suitable memory) and size, and in some cases may be implemented with volatile memory, non-volatile memory, or a combination thereof. A given processor 116 may be configured to perform operations associated with luminaire 104 and one or more applications or programs thereof (e.g., within memory 114). In some cases, memory 114 may be configured to be utilized, for example, for processor workspace (e.g., for one or more processors 116) and/or to store media, programs, applications, and/or content on luminaire 104 on a temporary or permanent basis.

The one or more applications/programs stored in memory 114 can be accessed and executed, for example, by the one or more processors 116 of luminaire 104. In accordance with some embodiments, a given module of memory 114 can be implemented in any suitable standard and/or custom/proprietary programming language, such as, for example C, C++, objective C, JavaScript, and/or any other suitable custom or proprietary instruction sets. The applications/programs of memory 114 can be encoded, for example, on a machine-readable medium that, when executed by a processor 116, carries out the functionality of luminaire 104. The computer-readable medium may be, for example, a hard drive, a compact disk, a memory stick, a server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose-built logic. Some embodiments can be implemented with a microcontroller having input/output capability (e.g., inputs for receiving user inputs; outputs for directing other components) and a number of embedded routines for carrying out the device functionality. The applications/programs les of memory 114 can be implemented in hardware, software, and/or firmware, as desired for a given target application or end-use.

In accordance with some embodiments, memory 114 may have stored therein (or otherwise have access to) one or more applications. In some instances, luminaire 104 may be configured to receive input, for example, via one or more applications stored in memory 114 (e.g., such as a lighting pattern, LCom data, etc.). Other suitable programs, applications, and data which may be stored in memory 114 (or may be otherwise accessible to luminaire 104) will depend on a given application.

In accordance with some embodiments, the one or more solid-state light sources 110 of luminaire 104 can be electronically controlled, for example, to output light and/or light encoded with LCom data (e.g., an LCom signal S1). Luminaire 104 may include or otherwise be communicatively coupled with one or more controllers 118, in accordance with some embodiments. Controller 118 may be hosted by luminaire 104 and operatively coupled (e.g., via a communication bus/interconnect) with the one or more solid-state light sources 110 (1-N). In other examples, a controller 118 may be hosted in whole or in part by individual solid-state light sources 110. Controller 118 may output a digital control signal to any one or more of the solid-state light sources 110 and may do so, for example, based on wired and/or wireless input received from a given local source (e.g., such as memory 114 or processor 116) and/or remote source (e.g., such as a control interface, network 120, etc.). As a result, luminaire 104 may be controlled in such a manner as to output any number of output beams (1-N), which may include light and/or LCom data (e.g., an LCom signal), as desired for a given target application or end-use.

In accordance with some embodiments, a given controller 118 may host one or more lighting control modules and can be programmed or otherwise configured to output one or more control signals, for example, to adjust the operation of the solid-state emitter(s) of a given solid-state light source 110. For example, in some cases, a given controller 118 may be configured to output a control signal to control whether the light beam of a given solid-state emitter is on/off. In some instances, a given controller 118 may be configured to output a control signal to control the intensity/brightness (e.g., dimming; brightening) of the light emitted by a given solid-state emitter. In some cases, a given controller 118 may be configured to output a control signal to control the color (e.g., mixing, tuning) of the light emitted by a given solid-state emitter. Thus, if a given solid-state light source 110 includes two or more solid-state emitters configured to emit light having different wavelengths, the control signal may be used to adjust the relative brightness of the different solid-state emitters in order to change the mixed color output by that solid-state light source 110. In some embodiments, controller 118 may be configured to output a control signal to an encoder to facilitate encoding of LCom data for transmission by luminaire 104. In some embodiments, controller 118 may be configured to output a control signal to a modulator to facilitate modulation of an LCom signal for transmission by luminaire 104. Other suitable configurations and control signal output for a given controller 118 of luminaire 104 will depend on a given application and will be apparent in light of this disclosure.

In accordance with some embodiments, luminaire 104 may include a communication module 122, which may be configured for wired (e.g., Universal Serial Bus or USB, Ethernet, FireWire, etc.) and/or wireless (e.g., Wi-Fi, Bluetooth, etc.) communication, as desired. In accordance with some embodiments, communication module 122 may be configured to communicate locally and/or remotely utilizing any of a wide range of wired and/or wireless communications protocols, including, for example, a digital multiplexer (DMX) interface protocol, a Wi-Fi protocol, a Bluetooth protocol, a digital addressable lighting interface (DALI) protocol, a ZigBee protocol, and/or a combination of any one or more thereof. Any suitable communications protocol, wired and/or wireless, standard and/or custom/proprietary, may be utilized by communication module 122, as desired for a given target application or end-use. In some instances, communication module 122 may be configured to facilitate inter-luminaire communication between luminaires 104. Communication module 122 may be configured to use any suitable wired and/or wireless transmission technologies (e.g., radio frequency, or RF, transmission; infrared, or IR, light modulation; etc.), as desired for a given target application or end-use. Other suitable configurations for communication module 122 will depend on a given application and will be apparent in light of this disclosure.

In accordance with some embodiments, luminaire 104 may include one or more additional components, such as an encoder, modulator, multiplier, adder and digital-to-analog converter (DAC) (not illustrated). In some embodiments, encoder may be configured, for example, to encode LCom data in preparation for transmission thereof by luminaire 104. In some embodiments, a modulator may be configured, for example, to modulate an LCom signal in preparation for transmission thereof by luminaire 104. In accordance with some embodiments, a multiplier may be configured to combine an input received from a modulator with an input received from an ambient light sensor (not illustrated) and may be configured to increase and/or decrease the amplitude of a signal passing therethrough, as desired. In accordance with some embodiments, an adder may be configured to combine an input received from a multiplier with a DC level input. In some instances, an adder may be configured to increase and/or decrease the amplitude of a signal passing therethrough, as desired. In accordance with some embodiments, a digital-to-analog converter (DAC) may be configured to convert a digital control signal into an analog control signal to be applied to a given solid-state light source 110 to output an LCom signal therefrom.

Components of Mobile Commissioning Device 102

In the illustrated example, MCD 102 may be configured to detect light pulses encoding an LCom signal S1 emitted by a transmitting luminaire 104 and decode data in the LCom signal S1 to determine, e.g., the ID of luminaire 104. In some examples, as described more below, data in the LCom signal S1 may also include position information, e.g., X, Y, Z global coordinates, of the luminaire 104. MCD 102 may also be configured to determine its position relative to the luminaire and to utilize SLAM algorithms to determine the position of additional luminaires 104.

In the illustrated example, MCD 102 includes a memory 130 and one or more processors 132. Memory 130 can be any suitable type (e.g., RAM and/or ROM, or other suitable memory) and size, and in some cases may be implemented with volatile memory, non-volatile memory, or a combination thereof. A given processor 132 of MCD 102 may be configured, for example, to perform operations associated with MCD 102 and one or more applications/programs thereof (e.g., within memory 130 or elsewhere). In some cases, memory 130 may be configured to be utilized, for example, for processor workspace (e.g., for one or more processors 132) and/or to store media, programs, applications, and/or content on MCD 102 on a temporary or permanent basis.

The one or more modules stored in memory 130 can be accessed and executed, for example, by the one or more processors 132 of MCD 102. In accordance with some embodiments, a given application/program of memory 130 can be implemented in any suitable standard and/or custom/proprietary programming language, such as, for example, C, C++, objective C, JavaScript, and/or any other suitable custom or proprietary instruction sets. The applications/programs of memory 130 can be encoded, for example, on a machine-readable medium that, when executed by processor 132, carries out the functionality of MCD 102, in part or in whole. The computer-readable medium may be, for example, a hard drive, a compact disk, a memory stick, a server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose-built logic. Some embodiments can be implemented with a microcontroller having input/output capability (e.g., inputs for receiving user inputs; outputs for directing other components) and a number of embedded routines for carrying out the device functionality. The applications/programs of memory 130 (e.g., such as an operating system, user interface (UI), and/or one or more applications 134, (discussed below) can be implemented in hardware, software, and/or firmware, as desired for a given target application or end-use.

In accordance with some embodiments, memory 130 may have stored therein (or otherwise have access to) one or more applications 134. In some instances, MCD 102 may be configured to receive input, for example, via one or more applications 134 stored in memory 130. In other examples, one or more of applications 134 may be stored in memory located outside of MCD 102, and/or one or more of the applications may be executed by one or more processors (not illustrated) located outside of MCD. For example, one or more of applications 134 may be executed by an external computing device (not illustrated) in communication with MCD 102. As shown in FIG. 1, applications 134 may include an LCom application 136 configured to process images captured by ICD 108 to identify light 106 emitted by one or more luminaires 104 and to identify and decode signals S1 encoded in the emitted light. Any algorithms and image processing techniques known in the art for LCom may be used, such as those disclosed in P.C.T. Patent Application No. PCT/US2017/051265, filed on Sep. 13, 2017 and titled, “Techniques for Decoding Light-Based Communication Messages,” which is incorporated by reference herein in its entirety. LCom application 136 may be configured to identify a unique ID contained in signal S1 encoded in the light 106 being emitted by luminaire 104 for processing by MCD 102.

Applications 134 may also include one or more image processing applications 138 for determining a position of MCD 102 relative to objects identified in images captured by ICD 108. In one example, luminaires 104 may be identified in captured images and a position of the luminaires on the image, e.g., in terms of camera sensor pixel coordinates, can be found by image processing techniques such as color/intensity thresholding, contour analysis, and center of geometry estimation techniques. A position and orientation of ICD 108 and MCD 102 relative to the identified luminaires can then be calculated, for example, by the principle of perspective-n-point (camera pose estimation). If the actual location of one or more of the luminaires 104 captured in an image is known, the actual location of ICD 108 and MCD 102 may, therefore, be determined via image processing applications 138. Any of a variety of image processing applications and techniques for determining a position of ICD 108 relative to an imaged object may be used, such as those disclosed in U.S. patent application Ser. No. 15/779,608, filed on Dec. 5, 2016 and titled, “Light-Based Vehicle Positioning For Mobile Transport Systems,” which is incorporated by reference herein in its entirety.

Applications 134 may also include one or more simultaneous localization and mapping (SLAM) applications 140 for constructing and/or updating a virtual map of an unknown environment, such as a space where an installation of luminaries are located, while simultaneously keeping track of the location of MCD 102 within the space. SLAM applications 140 may be configured to identify natural visual features captured in one or more images, such as a ceiling, and/or other structures within the environment. Any of a variety of feature detectors may be used, such as Oriented FAST and Rotated BRIEF (“ORB”) and/or scale-invariant feature transform (SIFT). SLAM applications 140 may be configured to build up a computer virtual environment, referred to herein as a virtual map (virtual map 142) and determine the position and orientation of ICD 108 within the virtual map. As shown in FIG. 1, virtual map 142 may be stored locally in memory 130 and/or may be communicated, e.g., via network 120 to a remote computational device (not illustrated). The relation between virtual map 142 and the real environment (e.g., a “global” reference coordinate system) may be calculated by determining the actual position and orientation of ICD 108 within the real world (“global” reference coordinate system) by utilizing image processing applications 138 and imaging one or more luminaires 104 of known location as described above. Meanwhile, the position and orientation of ICD 108 within virtual map 142 can be calculated using SLAM applications 140. By having the position and orientation of ICD 108 calculated for both the virtual map 142 and the real world at several locations of ICD 108, the relation between the virtual map 142 and the real world can be established and stored in memory 130 as a virtual-real transformation 144. As described more below, once the relation between virtual map 142 and the real world is established, one may calculate the location of ICD 108, the natural visual features captured in images, and luminaire positions back-and-forth between the virtual map 142 and real world global coordinates. In examples in which images from only one ICD 108 are used to create virtual map 142, the virtual map can be arbitrarily scaled and transformed (rotated, and shifted) relative to the real environment (i.e., to a “global” reference coordinate system). In examples in which MCD 102 includes two or more ICDs 108, the virtual-real transformation 144 may be determined from images taken by the MCD from only one location within a space, or from images taken at multiple locations.

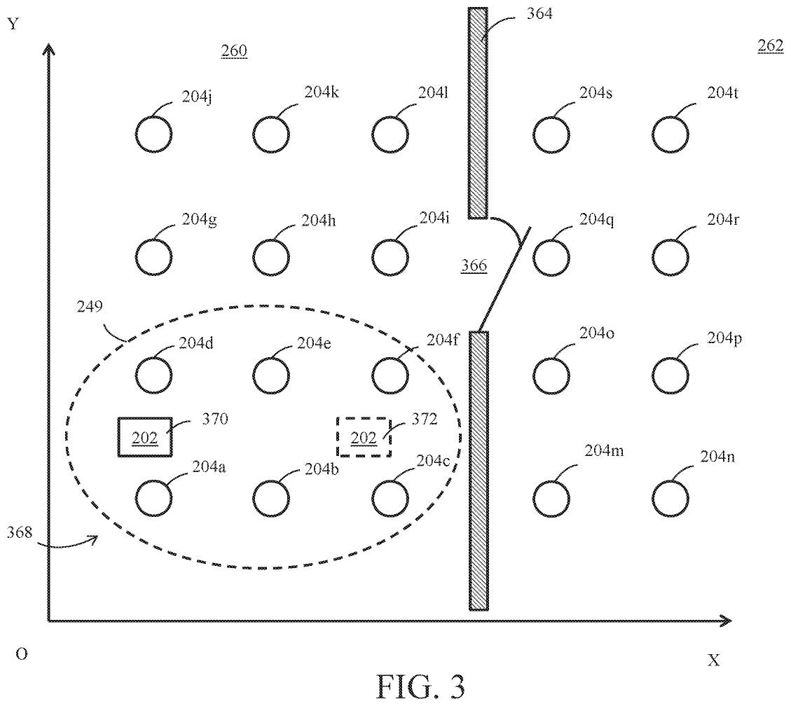

Memory 130 may also include a luminaire location database 146. As described more below, a location of a group of luminaires 104, referred to herein as an “anchor group” (e.g., anchor group 368, FIG. 3), may be known, for example, by manual measurement or some other means. The location of each luminaire 104 in the anchor group can be described with respect to a real world or global coordinate system with an arbitrarily selected origin such as the corner of a room, for example, in terms of X, Y, Z coordinates, with the global coordinates and unique ID of each luminaire 104 in the anchor group stored in luminaire location database 146. MCD 102 may also store the location of the remaining luminaires 104 of an installation being commissioned as they are determined by the MCD 102. As described more below, in another example, in addition to storing a unique ID in memory 114, each luminaire 104 with a predetermined location (e.g. luminaires in an anchor group) may also store its location coordinates in memory 114 and signal S1 encoded in light 106 may include both the luminaire unique ID and its coordinates. In such an example, MCD 102 may use the location information transmitted by a luminaire rather than accessing the location information from luminaire location database 146.

In accordance with some embodiments, MCD 102 may include a communication module 148, which may be configured for wired (e.g., Universal Serial Bus or USB, Ethernet, FireWire, etc.) and/or wireless (e.g., Wi-Fi, Bluetooth, etc.) communication using any suitable wired and/or wireless transmission technologies (e.g., radio frequency, or RF, transmission; infrared, or IR, light modulation; etc.), as desired. In accordance with some embodiments, communication module 148 may be configured to communicate locally and/or remotely utilizing any of a wide range of wired and/or wireless communications protocols, including, for example, a digital multiplexer (DMX) interface protocol, a Wi-Fi protocol, a Bluetooth protocol, a digital addressable lighting interface (DALI) protocol, a ZigBee protocol, and/or a combination of any one or more thereof. Any suitable communications protocol, wired and/or wireless, standard and/or custom/proprietary, may be utilized by communication module 148, as desired for a given target application or end-use. In some instances, communication module 148 may be configured to communicate with one or more luminaires 104. In some cases, communication module 148 of MCD 102 and communication module 122 of luminaire 104 may be configured to utilize the same communication protocol. In some cases, communication module 148 may be configured to communicate with a network 120.

MCD 102 may include one or more image capture devices 108 each having a field of view (FOV) 149. Image capture device 108 can be any device configured to capture digital images, such as a still camera (e.g., a camera configured to capture still photographs) or a video camera (e.g., a camera configured to capture moving images including a plurality of frames). In some cases, image capture device 108 may include components such as, for instance, an optics assembly, an image sensor, and/or an image/video encoder, and may be integrated, in part or in whole, with MCD 102, which may be implemented in any combination of hardware, software, and/or firmware, as desired for a given target application or end-use. Image capture device 108 can be configured to operate using light, for example, in the visible spectrum and/or other portions of the electromagnetic spectrum including but not limited to the infrared (IR) spectrum, ultraviolet (UV) spectrum, etc. In some instances, image capture device 108 may be configured to continuously acquire imaging data. MCD 102 may be configured to detect the light 106 and LCom signal S1 encoded therein in images captured by ICD 108. Memory 130 may also include calibration data associated with ICD 108, which may be used by one or more applications 134. Calibration data may be obtained from a geometric camera calibration, also referred to as camera re-sectioning, which estimates the parameters of a lens and image sensor of ICD 108. The calibration data may include parameters that affect the imaging process, including image center, focal length, scaling factors, skew factor, and lens distortions.

In accordance with some embodiments, MCD 102 may include one or more sensors 150, which may include a geomagnetic sensor, ambient light sensor, gyroscopic sensor and/or an accelerometer. A geomagnetic sensor may be configured to determine the orientation and/or movement of MCD 102 relative to a geomagnetic pole (e.g., geomagnetic north) or other desired heading, which may be customized as desired for a given target application or end-use. An ambient light sensor may be configured to detect and measure ambient light levels in the surrounding environment of MCD 102. A gyroscopic sensor may be configured to determine an orientation (e.g., roll, pitch, and/or yaw) of MCD 102. And an accelerometer may be configured to detect a motion of the MCD 102. Such sensors may be used in combination with the image processing discussed herein to determine a position, orientation, and/or trajectory of MCD, e.g., during a luminaire commissioning process.

In accordance with some embodiments, MCD 102 may also include a mobility system 152 to facilitate the movement of MCD 102 throughout a space where a system of luminaires are installed. Mobility system 152 may include any of a variety of mechanical and electrical components or modules known in the art for enabling the movement of MCD 102. In some examples, MCD 102 may be a robot, autonomous vehicle, or drone and mobility system 152 may include any associated components, such as an electric drivetrain, wheels, and steering in the case of an autonomous vehicle. In other examples, mobility system may simply include wheels for pushing or pulling MCD 102 around a space. And in some examples, MCD 102 may be configured to be carried by hand and thus not include a mobility system. Mobility system 152 may be remotely controlled by a user via wireless communication between a remote control (not illustrated) and communication module 148. In other examples, MCD 102 is configured to autonomously navigate a space using, e.g., SLAM applications 140.

In accordance with some embodiments, MCD 102 may include or otherwise be communicatively coupled with one or more controllers 154. Controller 154 may be configured to output one or more control signals to control any one or more of the various components/modules of MCD 102 and may do so, for example, based on wired and/or wireless input received from a given local source (e.g., such as memory 130) and/or remote source (e.g., such as a control interface, network 120, etc.). In accordance with some embodiments, controller 154 may host one or more control modules and can be programmed or otherwise configured to output one or more control signals, for example, to adjust the operation of a given portion of MCD 102. For example, in some cases, controller 154 may be configured to output a control signal to control operation of image capture device 108 or one or more components of mobility system 152. In some instances, controller 154 may be configured to output a control signal to control operation of one or more sensors.

Network 120 can be any suitable public and/or private communications network. For instance, in some cases, network 120 may be a private local area network (LAN) operatively coupled to a wide area network (WAN), such as the Internet. In some cases, network 120 may include one or more second-generation (2G), third-generation (3G), fourth-generation (4G), and/or firth-generation (5G) mobile communication technologies. In some cases, network 120 may include a wireless local area network (WLAN) (e.g., Wi-Fi wireless data communication technologies). In some instances, network 120 may include Bluetooth wireless data communication technologies. In some cases, network 120 may include supporting infrastructure and/or functionalities, such as a server and a service provider. In some instances, MCD 102 may be configured for communication with network 120 and one or more luminaires 104. In some cases, MCD 102 may be configured to receive data from network 120, for example, which may be used to supplement data received by MCD 102 from luminaire 104. In some instances, MCD 102 may be configured to receive data (e.g., such as position, ID, and/or other data pertaining to luminaire 104) from network 120 that facilitates indoor navigation via one or more luminaires 104. In some cases, network 120 may include or otherwise have access to one or more lookup tables of data that may be accessed by a MCD 102 communicatively coupled therewith. Numerous configurations for network 120 will be apparent in light of this disclosure.

### Example Implementation

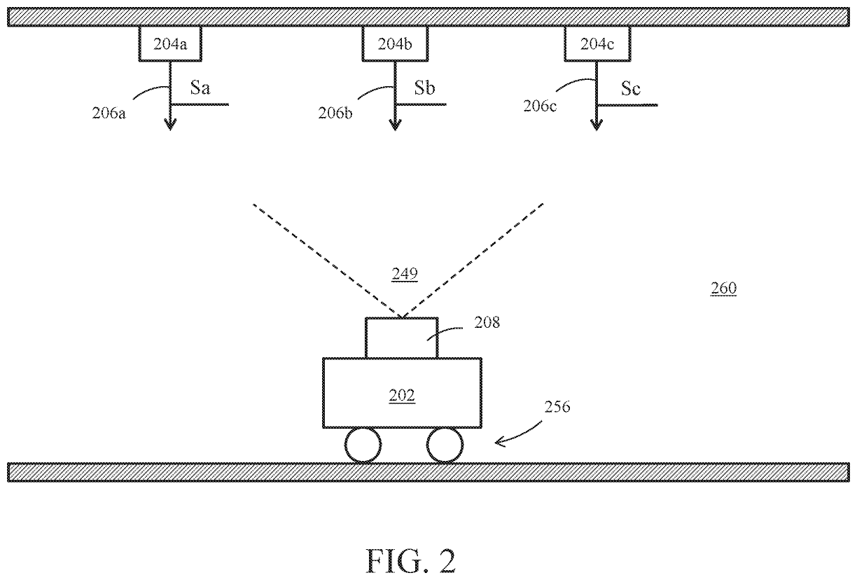

FIGS. 2 and 3 illustrate one example embodiment of a MCD 202 and an installation of luminaires 204a-204t to be commissioned by MCD 202. MCD 202 is an example implementation of MCD 102 and luminaires 204 are an example implementation of luminaire 104 (FIG. 1). Referring to FIG. 2, MCD 202 includes an ICD 208 having a FOV 249 that can capture a plurality of luminaires 204 in a single image. In the example embodiment of FIG. 2, MCD 202 is an autonomous vehicle and/or remote controlled vehicle including wheels 256 that can autonomously, or via remote control, navigate space 260 and 262 (FIG. 3). Each of luminaires 204a-204c are configured for LCom and emit light 206a-206c encoded with signal Sa-Sc, in which the signal S includes the unique ID of the corresponding luminaire 204. Referring to FIG. 3, in the illustrated example, luminaires 204a-204t are located in two spaces 260, 262 of a building separated by a wall 364 with doorway 366 providing passage therebetween. In the illustrated example, six luminaires 204a-204f form an anchor group 368 of luminaires, in which the location of each of luminaires 204a-204f in anchor group 368 is known, e.g., by measuring the location of each of the luminaires in the anchor group through the use of manual/hand measurement techniques or other means. Each of luminaires 204a-204f in anchor group 368 are configured for LCom and emit light 206 encoded with their unique ID. The global coordinates and unique ID of each luminaire 204a-204f in anchor group 368 can be stored, e.g. in luminaire location database 146 (FIG. 1) and/or in memory 114 of one or more of luminaires 204a-204f. In one example, the global coordinates of luminaires 204a-204f can be with respect to an arbitrary origin O, e.g., a corner of space 260 and in terms of Cartesian coordinates X, Y, and Z (the Z-axis is not illustrated and is perpendicular to the illustrated X and Y axes), although any other coordinate system (e.g., spherical coordinate system) or system of characterizing physical location may be used, such as characterizing luminaire location in terms of relative distances from one or more other locations, such as a relative distance from an adjacent luminaires. As described in more detail below in connection with FIG. 3, MCD 202 may capture one or more images of luminaries 204 in anchor group 368 and determine its actual position with respect to origin O and then navigate the remainder of spaces 260 and 262, imaging the remainder of luminaries 204g-204t, and determining the global coordinates X, Y, Z (also referred to herein as the global coordinate location) of each of the remaining luminaires.

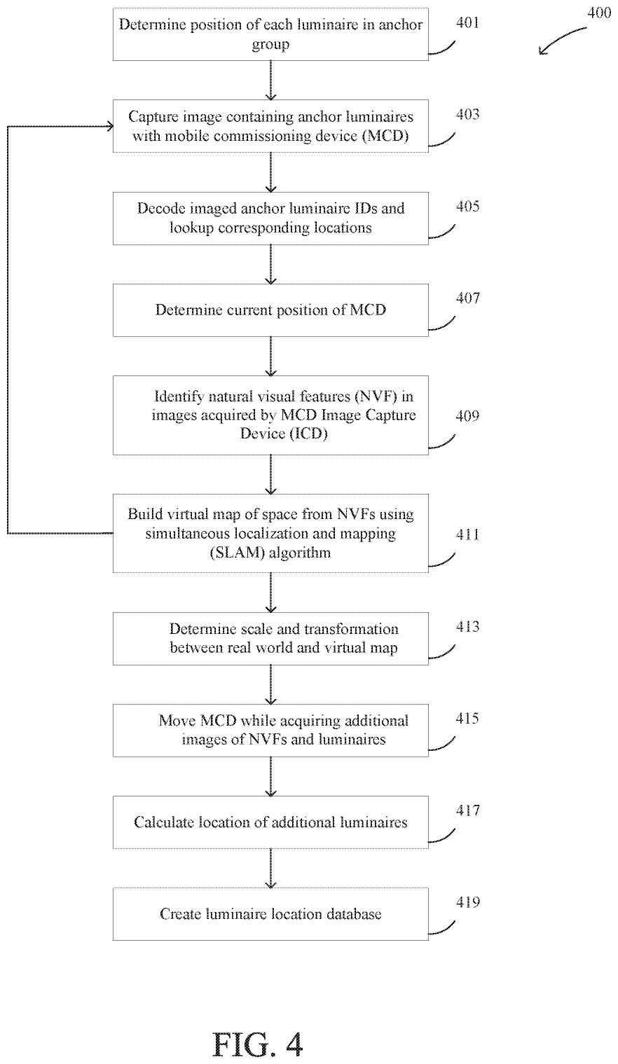

FIG. 4 illustrates one example method 400 of luminaire commissioning using computer vision and light communications. Method 400 may be performed by a MCD (e.g., MCD 102 or 202) for commissioning an installation of luminaires (e.g., luminaries 104, 204), in which at least some of the luminaires are configured for LCom. In block 401, the MCD may identify an anchor group of luminaires (e.g., anchor group 368 in FIG. 3) and determine the position of each luminaire in the anchor group through measurement, e.g., in terms of global coordinates with respect to some origin, and saved, e.g., in a luminaire location database (e.g., luminaire location database 146 in FIG. 1). As an alternative or in addition to saving the locations in a luminaire location database, the location information for each luminaire can be included in the signal encoded in the light emitted by each anchor group luminaire. In one example, at least three luminaires, and in some examples, at least five to seven luminaires are selected for the anchor group, and all or substantially all of the luminaires in the anchor group are located close enough together that they are within the FOV of the ICD (e.g., within FOV 249 of ICD 208 in FIG. 2). Increasing the number of luminaires in the anchor group and increasing the area spanned by the anchor group can improve accuracy of measurements by the MCD.

In block 403, the MCD may be positioned at a first location (e.g., first location 370 in FIG. 3) proximate the anchor group of luminaires and the MCD may capture one or more images containing all of the luminaires in the anchor group. In block 405, the MCD may decode a signal encoded in the light from each of the anchor group luminaires to determine the unique ID of each luminaire and look up its corresponding location from memory (e.g. luminaire location database 146 in memory 130 in FIG. 1). In block 407, after receiving location information for each of the anchor luminaires, MCD 202 may determine its current location relative to the anchor luminaires and its location in terms of global coordinates (e.g., X, Y, Z) using the image processing techniques described above (e.g., image processing applications 138). In block 409, MCD 202 may also begin to identify natural visual features in space 260 and in block 411, the MCD 202 may build a virtual map of space 260 using one or more SLAM applications (e.g. SLAM applications 140 in FIG. 1).

Blocks 403-411 may be repeated at additional locations. For example, MCD 202 may be moved to a second location within space where all or substantially all of the anchor group luminaires are within the FOV of the MCD ICD (e.g., second location 372 in FIG. 3, where FOV 249 is conceptually shown as encompassing each of luminaires 204a-204f when MCD 202 is in both the first and second locations 370, 372)). Blocks 403-411 may be repeated with the MCD in the second location to determine the global coordinates of the MCD when at the second location (blocks 403-407) and to identify additional natural visual features and continue to build the virtual map of space 260 (blocks 409 and 411). In examples where only one ICD is used, the virtual map created with SLAM applications may be arbitrarily scaled and transformed (rotated, and shifted) relative to the real environment (the global coordinate system). In block 413, the MCD may calculate the scale and transformation between the virtual map and real world after repeating blocks 403-411 in two or more locations (e.g., locations 370 and 372). In some embodiments, the MCD may be configured to store the virtual map and the virtual map-real world transformation in memory (e.g. virtual map 142 and virtual-real transformation 144 in memory 130 of FIG. 1).

With the location of MCD 102 determined in both the real and virtual environment, the commissioning process for the remaining luminaires 204g-204t may begin. At block 415, the MCD may be moved to additional locations within spaces 260 and 262 while continuously taking images of the space, and the MCD may use SLAM applications to simultaneously build a virtual map of the space while determining the location of the MCD within the space. In block 417, the MCD may capture images of the additional luminaires in the space and calculate the location of the luminaires in the virtual world and in terms of global coordinates using the methods disclosed herein. For example, the MCD may use LCom application 136 to determine the unique ID of an imaged luminaire, use image processing applications 138 to determine the location of the imaged luminaires relative to the MCD, and use SLAM applications 140, virtual map 142, and virtual-real transformation 144 to determine the location of the imaged luminaire in the virtual map and the real world. In one example, each of the additional 204g-204t may be configured for LCom and MCD 202 can also determine a unique ID for each of the additional luminaires 204g-204t by processing light emitted by each of the luminaires to determine a signal encoded in the light. In the example illustrated in FIGS. 2 and 3, blocks 415 and 417 may be repeated as the MCD moves away from the anchor group 368 of luminaires and can be repeated as the MCD moves into space 262 and beyond into other areas of the building (not illustrated). At block 419, with the locations of luminaires 204g-204t determined, the MCD may save the locations to a luminaire location database for future use.

As will be appreciated by a person having ordinary skill in the art, a number of variations to example method 400 may be implemented, such variations being within the scope of the present disclosure. For example, techniques other than modulating light using LCom may be utilized for determining a unique ID of one or more of the luminaires. For example, a static spatial pattern may be encoded, e.g. in non-visible light, such as IR, for processing by the MCD. In another example, one or more luminaires may not transmit any information. For example, for blocks 415 and 417, where a location of luminaires outside the anchor group are determined, luminaire location database may have approximate location information of the remaining luminaires, e.g., relative to one or more anchor luminaries, adjacent luminaires, and/or natural visual features, and MCD may be configured to deduce the specific luminaires being imaged from the approximate location information and calculate an exact location of each luminaire. In yet other examples, at block 401 a position of additional luminaires outside of a closely-spaced anchor group can be measured. For example, one or more additional luminaires throughout a space can be measured and added to the luminaire location database for improved accuracy. For example, if a total number of 100 luminaires are installed, one may manually measure additionally 5-10 luminaires that are far apart from one-another. Similarly, the results can be stored also in a database for use during commissioning. For example, with reference to FIG. 3, a location of luminaires 204j, 204t, and 204n may also be measured. During blocks 415 and 417, when MCD 202 captures images of luminaires 204j, 204t, and 204n, the calculated location can be compared to the previously-measured location and adjustments made to reduce error. Blocks 401-419 can also be repeated multiple times as part of a commissioning process to reduce error. In another example, an MCD can be equipped with two or more ICDs to obtain stereo images of the space, which could potentially provide more accurate commissioning measurements and/or could facilitate an easier process due to the depth information provided thereby. For example, blocks 403-411 may be performed once or fewer times than when one ICD is used. In yet another example, instead of all luminaires having LCom capability, only one luminaire out of a group of luminaires can have an identifiable unique ID and a predefined pattern of the group of luminaires relative to the one luminaire may be provided. For example the group of luminaires may form a predefined pattern such that the ICD could detect the pattern. For certain patterns, the ICD may also detect the position and orientation of the group of luminaires as a whole.

The foregoing has been a detailed description of illustrative embodiments of the disclosure. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments or examples, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure. Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

What is claimed is:

1. A method for determining a location of a plurality of luminaires installed in a space, the plurality of luminaires including an anchor group of luminaires and a second group of luminaires, the method comprising:
receiving, from an image capture device, a first image containing one or more of the luminaries in the anchor group;
determining, by a mobile commissioning device, a unique ID for at least one of the one or more luminaires in the anchor group from the first image;
obtaining, by the mobile commissioning device, location information of the at least one of the one or more luminaires in the anchor group based on the unique IDs;
determining, by the mobile commissioning device, a location of the mobile commissioning device based on the first image and the location information;
updating, by the mobile commissioning device, a virtual map of the space based on the first image;
receiving, from the image capture device, a second image containing a first luminaire in the second group of luminaires; and
calculating, by the mobile commissioning device, a location of the first luminaire from the second image and the virtual map.

2. The method of claim 1, wherein the unique ID for the at least one of the one or more luminaires in the anchor group is encoded in light signals emitted by the at least one of the one or more luminaires in the anchor group.

3. The method of claim 1, wherein obtaining location information of the at least one of the one or more luminaires in the anchor group comprises at least one of:
matching, by the mobile commissioning device, each unique ID with corresponding location information in a luminaire location database that associates unique IDs with luminaire locations; and
decoding, by the mobile commissioning device, the location information from light emitted by one or more of the luminaires in the anchor group that encode the location information.

4. The method of claim 1, wherein calculating the location of the first luminaire comprises:
determining, by the mobile commissioning device, a virtual location of the mobile commissioning device in the virtual map;
determining, by the mobile commissioning device, a virtual location of the first luminaire in the virtual map; and
converting, by the mobile commissioning device, the virtual location of the first luminaire to the location of the first luminaire in the space.

5. The method of claim 4, further comprising:
calculating, by the mobile commissioning device, a transformation between the virtual map and global coordinates in the space, wherein converting the virtual location of the first luminaire comprises converting the virtual location to a global coordinate location in the space using the transformation.

6. The method of claim 1, wherein the mobile commissioning device executes a simultaneous localization and mapping application to update the virtual map of the space and calculate the location of the first luminaire simultaneously.

7. The method of claim 1, further comprising:
determining, by the mobile commissioning device, a unique ID of the first luminaire from the second image, wherein the first luminaire encodes its unique ID in a light signal emitted by the first luminaire.

8. The method of claim 1, wherein the mobile commissioning device is an autonomous vehicle.

9. A computing device configured to determine a location of a plurality of luminaires installed in a space, the plurality of luminaires including an anchor group of luminaires and a second group of luminaires, the computing device comprising:
an image capture device configured to:
obtain a first image containing one or more of the luminaries in the anchor group; and
obtain a second image containing a first luminaire in the second group of luminaires; and
a processor configured to:
determine a unique ID for at least one of the one or more luminaires in the anchor group from the first image;
obtain location information of the at least one of the one or more luminaires in the anchor group based on the unique IDs;
determine a location of the computing device based on the first image and the location information;
update a virtual map of the space based on the first image;
receive the second image from the image capture device; and
calculate a location of the first luminaire from the second image and the virtual map.

10. The computing device of claim 9, wherein the unique ID for the at least one of the one or more luminaires in the anchor group is encoded in light signals emitted by the at least one of the one or more luminaires in the anchor group.

11. The computing device of claim 9, wherein the processor is configured to obtain location information of the at least one of the one or more luminaires in the anchor group by at least one of:
matching each unique ID with corresponding location information in a luminaire location database that associates unique IDs with luminaire locations; and
decoding the location information from light emitted by one or more of the luminaires in the anchor group that encode the location information.

12. The computing device of claim 9, wherein the processor is configured to calculate the location of the first luminaire by:
determining a virtual location of the mobile commissioning device in the virtual map;
determining a virtual location of the first luminaire in the virtual map; and
converting the virtual location of the first luminaire to the location of the first luminaire in the space.

13. The computing device of claim 12, wherein the processor is further configured to:
calculate a transformation between the virtual map and global coordinates in the space, wherein converting the virtual location of the first luminaire comprises converting the virtual location to a global coordinate location in the space using the transformation.

14. The computing device of claim 9, wherein the processor is configured to execute a simultaneous localization and mapping application to update the virtual map of the space and calculate the location of the first luminaire simultaneously.

15. The computing device of claim 9, wherein the processor is further configured to:
determine a unique ID of the first luminaire from the second image, wherein the first luminaire encodes its unique ID in a light signal emitted by the first luminaire.

16. The computing device of claim 9, wherein the computing device is an autonomous vehicle.

17. A non-transitory processor-readable storage medium having stored thereon processor executable instructions configured to cause a processor of a controller to perform operations comprising:
receiving, from an image capture device, a first image containing one or more luminaries in an anchor group of luminaires in a space;
determining a unique ID for at least one of the one or more luminaires in the anchor group from the first image;
obtaining location information of the at least one of the one or more luminaires in the anchor group based on the unique IDs;
determining a location of the mobile commissioning device based on the first image and the location information;
updating a virtual map of the space based on the first image;
receiving, from the image capture device, a second image containing a first luminaire in a second group of luminaires in the space; and
calculating a location of the first luminaire from the second image and the virtual map.

18. The non-transitory processor-readable storage medium of claim 17, wherein obtaining location information of the at least one of the one or more luminaires in the anchor group comprises at least one of:
matching each unique ID with corresponding location information in a luminaire location database that associates unique IDs with luminaire locations; and
decoding the location information from light emitted by one or more of the luminaires in the anchor group that encode the location information.

19. The non-transitory processor-readable storage medium of claim 17, wherein calculating the location of the first luminaire comprises:
determining a virtual location of the mobile commissioning device in the virtual map;
determining a virtual location of the first luminaire in the virtual map; and
converting the virtual location of the first luminaire to the location of the first luminaire in the space.

20. The non-transitory processor-readable storage medium of claim 19, further comprising:
calculating a transformation between the virtual map and global coordinates in the space, wherein converting the virtual location of the first luminaire comprises converting the virtual location to a global coordinate location in the space using the transformation.
